(19) United States
(12) Patent Application Publication
(10) Pub. No.: US 2017/0010227 A1
(43) Pub. Date: Jan. 12, 2017

(54) A MEASUREMENT SYSTEM FOR GAMMA ACTIVATION ANALYSIS

(71) Applicant: APPLIED PHYSICS INSTRUMENTS API OY, Espoo (FI)

(72) Inventor: Yury, N. BURMISTENKO, MOSCOW (RU)

(21) Appl. No.: 15/120,614

(22) PCT Filed: Feb. 20, 2014
(86) PCT No.: PCT/FI2014/050129

§ 371 Date: Aug. 22, 2016

(51) Int. Cl. G01N 23/221; G01V 5/00

(52) U.S. Cl. CPC G01N 23/221; G01V 5/00; G01N 2223/616

(57) ABSTRACT

A measurement system for a gamma activation analysis is configured to be utilized in a determination of concentration of at least one material under focus in a sample. The system includes a radiation source for providing a radiation beam, an irradiation device for storing at least temporarily the sample under irradiation, a radiation detector for measuring emitted radiation from the irradiated sample, a computing unit for determining the concentration of at least one material under focus in the sample, wherein the measurement system further including a transport channel, which transport channel provides a first delivery channel portion from a sample material input of the system to the irradiation device and a second delivery channel portion from the irradiation device to the radiation detector for measurement wherein the sample material is configured to be delivered in the first and the second channel portion.

### TECHNICAL FIELD

The invention concerns in general the technical field of radiation physics. Especially the invention concerns a composition analysis of a sample with radiation.

### BACKGROUND OF THE INVENTION

Gamma activation analysis is a technique for determining amount of elements in samples. The sample is irradiated with a radiation beam, which energizes, i.e. activates, nucleus of the elements in the sample. The analysis of the elements may be done by monitoring relaxation of the energized states of the nucleus of the elements and determining the elements in the sample by analyzing an energy spectrum of the excitations.

The gamma activation analysis is applied in a mining industry, where the aim is a grade control in mining by analyzing samples of ore continuously during the mining. FIG. 1 illustrates a prior art solution for ore analysis. Within the solution one or more sample containers 101 are brought in a loading drum 103 to an input of the system. The ore for the sample is typically crushed to a particle size of 1 mm and weighting around 500 g per sample. Moreover, the sample is stored in a plastic container, such as polyethylene container. Prior to inputting the samples in the system they are weighted with a weighting device 105 and labeled with a sample coding device 107 for a later need. The sample containers 101 are loaded in the system through an input channel 109 and taken into an irradiation device 111 wherein the radiation beam from the radiation source 113, such as linear electron accelerator, is directed. The radiation source 113 may be any other source providing bremsstrahlung gamma radiation. The radiation beam is measured and monitored with a radiation monitoring device 115 in order to collect information on the radiation. The irradiation device 111 is configured to cause the sample to rotate when the sample is irradiated in order to provide uniform amount of irradiation to the sample. The radiation energizes at least some elements in the sample and the irradiated sample is taken to a radiation detector 117 for determining the radiation energy of irradiated sample, when the energized states of the elements in the sample are relaxed. In other words when the sample is irradiated at least some of the elements in the sample may get energized and when the sample is taken to an analysis the energized states of the elements are relaxed by emitting radiation at the characteristics energy of the element in question. The energy spectrum can thus be determined for the sample. The radiation detector comprises means for detecting radiation originating from the relaxation of an element under measurement back to the stable state.

The system further comprises collecting and computing unit 119, such as applicable sensors and computers, for collecting information on weights of samples, information from the sample coding device 107, information on the radiation from the radiation monitoring device 115 and measurement results from the radiation detector 117. Based on the collected information the system may determine if a sample comprises gold and keep on track the information per sample, and produce measurement results 121.

In order to determine gold, or other element, concentration in a sample, each sample needs to be packed in a container for the analysis. This requires resources, such as a sampling system, and increases the costs of the system. Additionally, the size of samples is limited according to the container size, which is a problem in a sense of increasing the representative of the analysis, and capacity of the system.

### SUMMARY OF THE INVENTION

An objective of the invention is to present a system for determining a concentration of at least one material under focus in a sample material with gamma activation analysis. Another objective of the invention is that the system for determining the concentration may produce the analysis for sample material input directly in the system without any container arrangement.

The objects of the invention are reached by a method, an apparatus and a computer program as defined by the respective independent claims.

According to a first aspect, a measurement system for a gamma activation analysis is provided, which system is configured to be utilized in a determination of concentration of at least one material under focus in a sample, the system comprising: a radiation source for providing a radiation beam; an irradiation device for storing at least temporarily the sample under irradiation, wherein the irradiation device comprises a drum-type structure configured to rotate around its axis; a radiation detector for measuring emitted radiation from the irradiated sample; a computing unit for determining the concentration of at least one material under focus in the sample; wherein the measurement system further comprising a transport channel, which transport channel provides a first delivery channel portion from a sample material input of the system to the irradiation device and a second delivery channel portion from the irradiation device to the radiation detector wherein the sample material is configured to be delivered in the first and the second channel portion, wherein the radiation beam originating from the radiation source is arranged to scan the sample material along an axis of the drum-type structure of the irradiation device.

The measurement system may further comprise a first guide plate arranged between the sample material input of the system and the irradiation device for controlling the delivery of the sample material in the delivery channel by opening and closing the delivery channel. Alternatively or in addition, the measurement system may further comprise a second guide plate arranged between the irradiation device and the radiation detector for controlling the delivery of the sample material in the delivery channel by opening and closing the delivery channel.

The irradiation device may comprise at least one opening for inputting and outputting the sample material in the irradiation device. The each of the at least one opening in the irradiation device may comprise a controllable cover plate.

The measurement system may further comprise a calibration arrangement in which a reference material for calibrating the operation of the system is arranged movably in the system, wherein the reference material is configured to be positioned under irradiation in a first position and to be positioned in the radiation detector in a second position. The calibration arrangement may comprise a wire and at least two pulleys, wherein the wire comprises the reference material and forms a loop over the two pulleys and wherein motion of the reference material in the wire between the mentioned positions is arranged with a motor providing energy to at least one of the pulleys. The positioning of the reference material in the mentioned positions may be configured to be performed concurrently with the delivery of the sample material between the irradiation device and the radiation detector. The reference material may be at least one of the following: hafnium, selenium.

The computing unit may further be configured to control the operation of the system.

The exemplary embodiments of the invention presented in this patent application are not to be interpreted to pose limitations to the applicability of the appended claims. The verb “to comprise” is used in this patent application as an open limitation that does not exclude the existence of also un-recited features. The features recited in depending claims are mutually freely combinable unless otherwise explicitly stated.

The novel features which are considered as characteristic of the invention are set forth in particular in the appended claims. The invention itself, however, both as to its construction and as its method of operation, together with additional objects and advantages thereof, will be best understood from the following description of specific embodiments when read in connection with the accompanying drawings.

### BRIEF DESCRIPTION OF DRAWINGS

FIG. 1 illustrates a prior art solution for ore analysis,

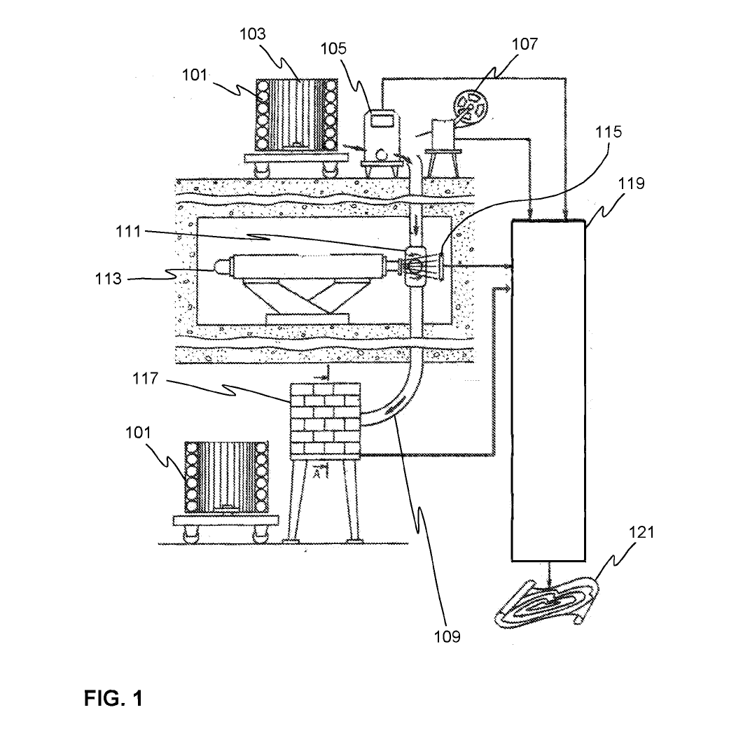

FIG. 2 illustrates an example of the system according to the invention, and

FIGS. 3a and 3b illustrate an example of the implementation of a radiation detector.

### DETAILED DESCRIPTION

The present invention relates to a measurement system, which can be applied to heavy weight sample gamma activation analysis. One principle of the present invention is that a material of a sample i.e. the material intended for the analysis without packing it necessarily in any container. Moreover, the amount of the sample material is large compared to prior art solution. The core idea is that the measurement system is configured to deliver a predetermined amount of the sample material in applicable form into irradiation and measurement units. The system is configured to control the delivery according to predefined operation of the system. Moreover, the system may be equipped with an auto-calibration unit, which is configured to carry reference material in order to provide information for maintaining the measurement results calibrated according to the operation of the system.

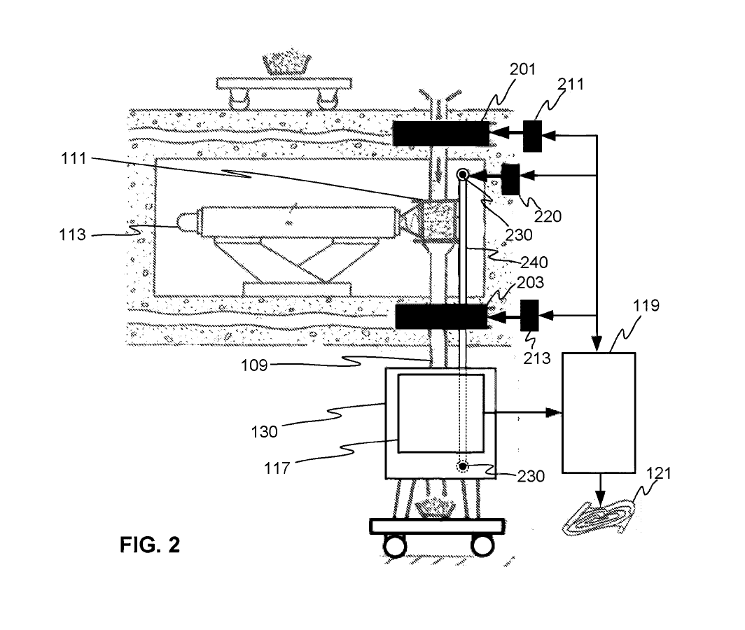

FIG. 2 illustrates an example of the system according to the invention. The measurement system according to the invention comprises a transport channel 109 through which the sample material can be delivered in the system and out from there. More specifically, the transport channel comprises and thus provides a first delivery channel portion for delivering a sample material from a sample material input of the system to the irradiation device 111 for irradiation and a second delivery channel portion for delivering the irradiated sample material from the irradiation device to the radiation detector for measurement. The transport channel is advantageously manufactured from a material, which stands stress in the application area. As said, the sample is conveyed to an irradiation device 111 through the transport channel. The irradiation device 111 is configured to hold the sample material in an irradiation when the radiation source 113 provides radiation. The gamma radiation energizes, i.e. activates, atoms of the elements in the sample. According to an example of the invention, the irradiation device 111 may comprise, or be, a drum-type, e.g. cylindrical, structure into which the sample material can be delivered. In order to irradiate the sample uniformly the drum-type structure in the irradiation device 111 is configured to be rotatable around its axis. The rotation of the of the irradiation device 111 may be arranged so that the drum-type structure is mounted onto a rotatable assembly into which the rotational power is brought from a motor, such as an electrical motor. Moreover, the irradiation device 111 comprises at least one opening for inputting and outputting the sample material in the irradiation device 111. Further, the at least one opening may be covered with a controllable cover plate, which may be opened when the sample material is brought in the irradiation device 111 and taken out from there. The radiation source 113 may be an electron accelerator supplied with an arrangement to oscillate the electron beam along the surface of linear target made from heavy metal, such as wolfram, tantalum or gold, for example. As a result bremsstrahlung is produced, which scans along an axis of the drum-shaped structure in the irradiation device. In other words, the radiation source 113 may be arranged to scan the sample material in the irradiation device along the axis of the drum-shaped structure in the irradiation device when the sample material is rotating in the irradiation device. As a result, the sample material can be irradiated uniformly. The scanning, or oscillation, is necessary when the width of the radiation beam in the direction of the axis of the drum-type structure of the irradiation device is less than the height of the drum-type structure in direction of the rotational axis of the drum-type structure. The electron accelerator may operate in a linear manner i.e. being a linear electron oscillator.

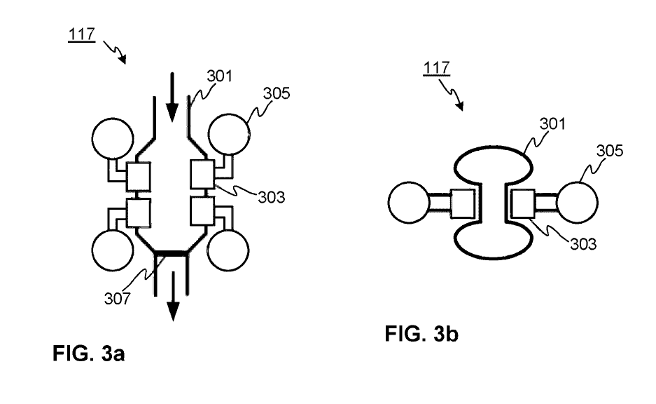

The system according to the invention also comprises a radiation detector 117 into which the sample material as well as the reference material is delivered in response to the irradiation. The radiation detector 117 is configured to monitor and measure a relaxation of the energized atoms in the sample and produce measurement information of the relaxation. The outcome of the measurement is an energy spectrum disclosing a number of pulses per the energy spectrum, which can be utilized in determining a concentration of elements in a sample. FIGS. 3a and 3b disclose an example of the implementation of a radiation detector 117. FIG. 3a discloses a side-view of the radiation detector 117 and FIG. 3b discloses a top view of the same radiation detector 117. The radiation detector 117 may comprise a predetermined number of, such as four, semiconductor detectors 303 of high-purity germanium (HPGe). The radiation detector 117 is configured to be cooled with a sophisticated cooling system 305 to reduce source of noise to the measurement. The cooling system may be an applicable cryogenic system, wherein the cooling of the detectors 303 is arranged so that a coolant in the cryogenic system is delivered to the detectors and back to the cryogenic system. As the sample material is directly input to the system it is advantageous to make sure that the detection of the relaxation of the energized atoms is optimal to the need. The optimization of the detection may be achieved by arranging an optimally shaped space 301, such as a container, in the radiation detector 117 by means of which the detectors may be at least partly positioned in the sample material, when the sample material is delivered in the radiation detector 117. This can be achieved by arranging the one or more detectors to intrude to the space into which the sample material is directed for measurement. In other words, it is advantageous to maximize the area of the detectors with the sample material by taking into account other possible limitations originating from the measurement system. In such a manner the semi-conductor detectors 303 are able to detect the radiation originating from the relaxation of the energized atoms in the sample material from as many directions as possible. The space for the sample material in the radiation detector 117 may comprise a controllable shutter 307 in order to control the delivery of the sample material out from the radiation detector 117. An example of the shape of the sample material space 301 in the radiation detector 117 can be seen in FIGS. 3a and 3b.

The system according to the example of the present invention as illustrated in FIG. 2 also comprises a computing unit 119. The computing unit may comprise one or more processors, one or more memories and necessary interfaces in order to communicate internally and externally. The computing unit 119 may be arranged to control the operation of the system as well as analyze information input therein. The mentioned operations are arranged to happen in response to an execution of computer program code stored in the memory of the computer unit 119, which computer program code comprises instructions to cause the computing unit 119 to operate in a predetermined manner. According to the present invention, the computing unit 119 is configured to analyze measurement results retrieved, or received, from the radiation detector 117. Alternatively or in addition, the computing unit 119 is configured to produce control signals for different entities belonging to the system according to the present example of the invention.

The delivery of the sample material in the system is controlled, according to the present example of the invention, with one or more guide plates arranged in the transport channel 109. The system as depicted in FIG. 2 discloses two guide plates 201, 203, which are sliding type of guide plates. The type of the guide plates may be any other than sliding type, such as swing type or any other applicable type. In other words they cut the transport channel 109 locally, when they are set to ‘closed’ state. The guide plates 201, 203 are configured to be set to ‘open’ state, which opens the transport channel 109 at least partly. The states of the guide plates 201, 203 are configured to be controlled by the computing unit 119 by instructing the operation of a power mechanism 211, 213 of the corresponding guide plate. The power mechanisms 211, 213 may be some type of motors, such as electrical motors configured to produce necessary energy to cause the guide plates to change states between the ‘open’ and ‘closed’ states. The energy from the electrical motors to the guide plates may be arranged through a known power transmission mechanism, such as utilization of transmission gear and necessary pulleys and belts in the power mechanisms 211, 213.

The system or at least parts of it may be protected in a way that at least part of a scattered radiation may be prevented. The protection may be arranged by placing the radiation source 113 in a space, which is covered with a protective material layer, such as with lead (Pb) or tungsten (W). The guide plates 201, 203 may also be manufactured with the same material. Additionally, the radiation detector 117 may advantageously be placed in a protective housing 130 in order to prevent any external noise ending up into the detectors. The protective housing 130 may be built up from lead bricks, for instance.

Furthermore, according to the example of the invention as illustrated in FIG. 2 the system may comprise a calibration arrangement for eliminating an influence of an instability of the radiation source 113 and the radiation detector 117. The calibration arrangement according to the present invention may comprise a wire 240 at least partly comprising an applicable reference material, which can be energized through irradiation and the relaxation of the energized state can be measured in the radiation detector 117. Advantageously the half-life time of the reference material is within predetermined limits in relation to the half-life time of the material under focus in the sample. The wire 240 is positioned so that it forms a loop over two pulleys 230 so the wire can be move through rotational movement of the pulleys. The rotation of the pulleys 230, and thus the move of the wire 240, may be arranged with an electric motor 220 producing the necessary energy for the rotational movement, which energy is taken to the pulley 230 or pulleys with a known transmission mechanism, e.g. with utilization of transmission gear and belt. The operation of the electric motor 220, in turn, may be controlled by the computing unit 119 according to a predetermined operational plan. Furthermore, the wire 240 is positioned so that it goes through the irradiation device 111 and the radiation detector 117 (dotted line in FIG. 2) so that the wire, and especially the reference material in the wire 240, receives proportionally the same amount of radiation as the sample material and the irradiated part of the wire 240 may be moved close to, or even through, the radiation detector 117 in order to enable the measurement of the relaxation of the reference material within the wire. For example, the movement of the wire in the radiation detector may e.g. be arranged by having a specific channel mounted in the radiation detector so that it passes the space 301 in such a manner that the detectors may detect in radiation origination from the relaxation of atoms in the reference material. The measurement information originating from the wire 240 may be used for calibrating the system. The positioning of the wire 240 is arranged according to the invention so that it does not disturb the operation of the rest of the system, such as changing the state of the guide plate 203 and vice versa. Above it is described that the wire partly contains of, or is manufactured from, a material applicable to be used as a reference material. Applicable material is, for example, hafnium or selenium arranged in the wire. According to some other example of the invention, the reference material may be arranged as discrete blocks in the wire 240. In any implementation of the wire it is necessary to confirm that the control of the move of the wire is accurate. This is important in a sense that the reference material receives proportionally the same amount of radiation as the sample material under irradiation and the measurement of the reference material is performed concurrently with the same sample material for a necessary period defined by the half-life time of the material under focus in the sample. In other words, the motion of the reference material and the sample material is arranged concurrently between the irradiation device i.e. irradiation and the radiation detector.

The solution as illustrates in FIG. 2 comprises a two pulley solution in which the wire of reference material is arranged to form a loop over the pulleys. However, any other solution for arranging and controlling the move of the wire may be applied. Such an applicable solution may be a winch arrangement in which the wire is spooled with a winch and thus providing controllability in the move of the wire. A winch may be arranged at both ends of the wire and the operation of the winches is configured to be controlled by the computing unit.

Next, the operation of the system is described. The sample material is configured to be in a predetermined form in order to go through the measurement system. Thus, the ore may be crushed into particles of predetermined size, such as a diameter of 7 mm, and taken to the input channel by means of containers or through a supply channel arranged between the crushing system and the measurement system. The material to be analyzed is input to the measurement system. An amount of material supplied in the measurement system at a time may e.g. be from 20 to 25 kg. The first guide plate 201 may be arranged to be either in open or closed state. In some implementation a weighting device is arranged on the guide plate for measuring the amount of material input to the system. According to an example of the invention, each sample is arranged to be identified from other sample by arranging an identifier in the sample material in question. The identifier is e.g. a RFID tag, which is added in the sample material. The identifier can be any other, preferably such which can be remotely read. When the predetermined amount of material is input the guide plate 201 is configured to be opened so that the sample material ends up in the irradiation device 111. According to the example of the invention the gravitation is used in the delivery of the sample material though transport channel 109. However, it is possible to arrange a power operated transport mechanism for transporting the sample material through the transport channel. When the material of a sample is in the irradiation device 111, the computing unit 119 is configured to give a control signal to the power mechanism 211 for producing the necessary power to control the guide plate 201 to close. Additionally, the radiation source 113, such as electron accelerator, is instructed to switch on by the computing unit 119 to irradiate the sample material. Additionally, a wire 240 made of reference material is arranged in the radiation. During the irradiation the irradiation device 111 is arranged to rotate around its axis in order to provide a uniform activation for the sample material.

The wire material, i.e. the reference material, gets also excited. When terminating the irradiation the computing unit 119 is configured to instruct the radiation source 113 to switch off and to instruct the irradiation device 111 to release the sample material, e.g. by opening a bottom of the irradiation device 111, in the transport channel. The computing unit 119 is also configured to instruct the power mechanism 213 of the second guide plate 203 to open so that the sample material can be delivered to the radiation detector 117. The guide plate 203 may also be instructed to close when the sample material is delivered to the radiation detector. The computing unit 119 may also be configured to instruct the power mechanism 220 providing the necessary power to the wire to operate and in response to the operation the radiated part of the wire 240 is also moved to the radiation detector 117. The move of the wire 240 preferably happens at least partly simultaneously with the transport of the sample material in the radiation detector 117. At least, the measurement is to be simultaneously done for both the irradiated sample material and the irradiated reference material in the wire 240, which both were excited in the irradiation. The induced activity of the sample material and the reference material of the wire 240 are measured over at least the half-life time of the sample material. When the measurement is done, the sample material is output from the radiation detector 117. The measure information is delivered to the computing unit 119, which is arranged to analyze a concentration of an element under focus in the sample by utilizing the information on the reference material for calibrating the operation of the system in each measurement. Finally, the computing unit 119 provides the result 121 of the measurement.

In the examples of the invention above the computing unit 119 is arranged to control the full operation of the system. However, the control and analyzing may be divided between two or more computing units and/or corresponding entities arranged to perform the mentioned operations. The mentioned units and entities are arranged to communicate with each other for coordinating the operation of the system as a whole. Alternatively or in addition, a control unit may be arranged to control the whole process only, but individual computing units are arranged to control small operative units within the system.

The advantage of the measurement system according to the description above is that there is no need put each sample into separate container for going through the whole system. This releases resources in the mines and analysis units. As well, the present invention enables larger through-put of sample material than the prior art solution. Moreover, the present invention provides a solution for taking the full advantage of high penetrating ability of the bremsstrahlung gamma radiation, as the size of the sample material per irradiation is big. Thus, the present invention increases the representativity of the whole analysis system.

Some advantageous embodiments according to the invention were described above. The invention is not limited to the embodiments described. The inventive idea can be applied in numerous ways within the scope defined by the claims attached hereto.

1-12. (canceled)

13. A measurement system for a gamma activation analysis, which system is configured to be utilized in a determination of concentration of at least one material under focus in a sample, the system comprising:
a radiation source for providing a radiation beam,
an irradiation device for storing at least temporarily the sample under irradiation, wherein the irradiation device comprises a drum-type structure configured to rotate around its axis,
a radiation detector for measuring emitted radiation from the irradiated sample,
a computing unit for determining the concentration of at least one material under focus in the sample,
wherein the measurement system further comprising a transport channel, which transport channel provides a first delivery channel portion from a sample material input of the system to the irradiation device and a second delivery channel portion from the irradiation device to the radiation detector wherein the sample material is configured to be delivered in the first and the second channel portion,
wherein the radiation beam originating from the radiation source is arranged to scan the sample material along an axis of the drum-type structure of the irradiation device.

14. The measurement system of claim 13, wherein the system further comprising a first guide plate arranged between the sample material input of the system and the irradiation device for controlling the delivery of the sample material in the delivery channel by opening and closing the delivery channel.

15. The measurement system of claim 13, wherein the system further comprising a second guide plate arranged between the irradiation device and the radiation detector for controlling the delivery of the sample material in the delivery channel by opening and closing the delivery channel.

16. The measurement system of claim 13, wherein the irradiation device comprises at least one opening for inputting and outputting the sample material in the irradiation device.

17. The measurement system of claim 16, wherein each of the at least one opening in the irradiation device comprises a controllable cover plate.

18. The measurement system of claim 13, wherein the system further comprising a calibration arrangement in which a reference material for calibrating the operation of the system is arranged movably in the system, wherein the reference material is configured to be positioned under irradiation in a first position and to be positioned in the radiation detector in a second position.

19. The measurement system of claim 18, the calibration arrangement comprises a wire and at least two pulleys, wherein the wire comprises the reference material and forms a loop over the two pulleys and wherein motion of the reference material in the wire between the mentioned positions is arranged with a motor providing energy to at least one of the pulleys.

20. The measurement system of claim 18, wherein the positioning of the reference material in the mentioned positions is configured to be performed concurrently with the delivery of the sample material between the irradiation device and the radiation detector.

21. The measurement system of claim 18, wherein the reference material is at least one of the following: hafnium, selenium.

22. The measurement system of claim 13, wherein the computing unit is further configured to control the operation of the system.
